(19) United States
(12) Patent Application Publication
(10) Pub. No.: US 2007/0168097 A1
(43) Pub. Date: Jul. 19, 2007

(54) Discrete hardware safing circuit

(75) Inventor: Daniel J. Vanderley, Hudsonville, MI (US)

Correspondence Address: FOLEY AND LARDNER LLP;SUITE 500, 3000 K STREET NW, WASHINGTON, DC, 20007, US

(73) Assignee: AUTOMOTIVE SYSTEMS LABORATORY, INC.

(21) Appl. No.: 11/333,261

(22) Filed: Jan. 18, 2006

(51) Int. Cl. B60R 21/00

(52) U.S. Cl. 701/45; 280/735; 180/271

(57) ABSTRACT

A discrete hardware safing circuit includes a sensor the provides a signal indicating a vehicle acceleration in a direction and at least one comparator that determines if the vehicle acceleration exceeds a predetermined threshold. A capacitive switch is activated based on a determination from the at least one comparator that the predetermined threshold was exceeded and remains activated as long as the predetermined threshold is exceeded and for an additional time period. A router routes an enable signal based on the activation of the capacitive switch.

### BACKGROUND OF THE INVENTION

1. Field of the Invention

Embodiments of the present invention relate to methods and apparatus for activating occupant protection devices of a vehicle, and in particular embodiments, to methods and apparatus for activating occupant protection devices of a vehicle using a discrete hardware safing circuit.

2. Description of the Related Art

Vehicle occupant protection systems that have at least one actuatable occupant protection device are known in the art. An actuatable occupant protection device of such a system is actuated upon the occurrence of a condition for which a vehicle occupant is to be protected. Two examples of conditions for which a vehicle occupant is to be protected are the occurrence of a vehicle frontal collision and the occurrence of a vehicle side collision of sufficient magnitude to cause bodily harm of the vehicle occupant.

One type of actuatable occupant protection system includes an air bag module mounted within a vehicle such that an air bag of the module is inflatable within an occupant compartment of the vehicle. The air bag is inflated upon the occurrence of a condition, such as a vehicle frontal collision of sufficient magnitude to cause bodily harm of a vehicle occupant. Another type of actuatable occupant protection system includes a side curtain module mounted within a vehicle such that an inflatable side curtain of the module is extendible between the vehicle occupant and side structure (e.g., door glass) of a vehicle. The side curtain is extended upon the occurrence of a condition, such as a vehicle side collision of sufficient magnitude to cause bodily harm of the vehicle occupant.

Typically, an occupant protection system includes a controller that controls actuation of the one or more occupant protection devices within the system. The control provided by the controller is in response to one or more signals provided from one or more crash sensors, or the processing of the one or more signals. For example, the occupant protection system may include an accelerometer that outputs a signal indicative of vehicle crash acceleration. The controller determines whether the signal is indicative of crash acceleration above a predetermined threshold. When the threshold is exceeded, the controller actuates one or more occupant protection devices.

Many known systems utilize sensory input from two sensors and/or the processing of the two sensory inputs in somewhat of a redundant fashion to make a final determination regarding actuation of an occupant protection device. Both sensory inputs must indicate, or result in determinations, that a crash condition is present in order for actuation to occur. Typically, the redundant aspect is referred to as providing a “safing” function. Within a system that has a safing arrangement, one sensor/processing arrangement is referred to as a primary and the other sensor/processing arrangement is referred to as the safing.

Although the conventional safing arrangements have been proven to be effective in preventing erroneous activation of the occupant protection devices due to the malfunctioning of a primary sensor/processing arrangement, a primary microprocessor, etc., these conventional safing arrangements are extremely expensive due to the cost of sophisticated components such as a microprocessor functioning as the controller of the safing arrangement, oscillators used for timing purposes or computer software providing instructions for many of these components.

In addition, with the conventional safing arrangements, the predetermined threshold values used to determine that a crash condition is present, cannot be readily changed to compensate for road and temperature conditions, aged deterioration of components, etc. In other words, the conventional safing arrangements cannot adequately compensate for deviations in the threshold value. This limitations prevents the conventional safing arrangements from outputting a signal to activate the occupant protection device when there is a deviation in the threshold value.

Therefore, it is desirable to provide a safing arrangement that can be incorporated in a vehicle occupant protection system, that is simplistic yet robust and reliable. It is also desirable to provide a safing arrangement that can be incorporated in a vehicle occupant protection system, that eliminates the large overhead of a safing microprocessor that is wastefully underutilized, thereby proportioning hardware and hardware costs to a single function. Also, it is desirable to provide a safing arrangement used in a vehicle occupant protection system, that allows for full tests of enable pins with the option of overriding the enable pin test logic with a received safing event signal. Furthermore, it is desirable to provide a safing arrangement used in a vehicle occupant protection system, that reliably outputs a signal to activate the occupant protection device even when there is a deviation in the threshold value.

### SUMMARY OF THE INVENTION

Embodiments of the present invention address the problems that have been discussed above and relate to embodiments of methods and apparatus for activating occupant protection devices of a vehicle using a discrete hardware safing circuit.

The discrete hardware safing circuit in accordance with an embodiment of the present invention includes a sensor the provides a signal indicating a vehicle acceleration in a direction and at least one comparator that determines if the vehicle acceleration exceeds a predetermined threshold. A capacitive switch is activated based on a determination from the at least one comparator that the predetermined threshold was exceeded and remains activated as long as the predetermined threshold is exceeded and for an additional time period. A router routes an enable signal based on the activation of the capacitive switch.

### BRIEF DESCRIPTION OF THE DRAWINGS

The foregoing and other features of embodiments of the present invention will become apparent to those skilled in the art to which the present invention relates upon reading the following description with reference to the accompanying drawings, in which:

FIG. 1 is a block diagram illustrating a vehicle occupant protection system incorporating a discrete hardware safing circuit according to one embodiment of the present invention.

FIG. 2 is a block diagram illustrating a one axis discrete hardware safing circuit for activating an occupant protection device according to one embodiment of the present invention.

FIG. 3 is a block diagram illustrating the one axis discrete hardware safing circuit incorporated in a vehicle occupant protection system according to one embodiment of the present invention.

FIG. 4 is a block diagram illustrating a two axis discrete hardware safing circuit for activating an occupant protection device according to another embodiment of the present invention.

FIG. 5 is a circuit diagram illustrating a digitally controlled router used in the discrete hardware safing circuit for activating an occupant protection device according to one embodiment of the present invention.

FIG. 6 is a circuit diagram illustrating an enable pin logic circuit used in a hardware safing circuit for activating an occupant protection device according to one embodiment of the present invention.

FIG. 7 is a circuit diagram illustrating the one axis hardware safing circuit for activating an occupant protection device according to one embodiment of the present invention.

FIG. 8 is a flow chart representing a process performed in accordance with one embodiment of the present invention.

### DETAILED DESCRIPTION OF THE INVENTION

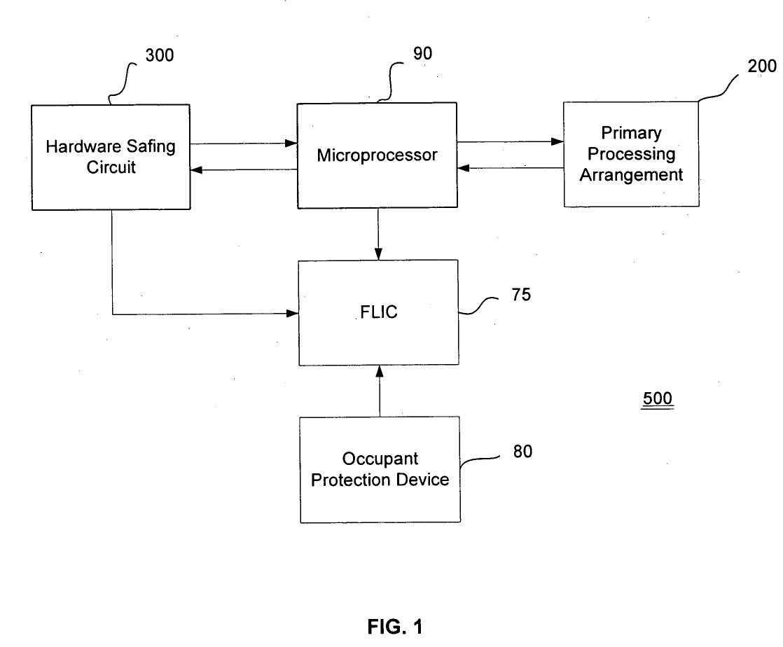

An explanation will be given regarding embodiments of the present invention while referring to the attached drawings. A vehicle occupant protection system for activating an occupant protection device of a vehicle incorporating the discrete hardware safing circuit according to an embodiment of the present invention is described with reference to FIG. 1. As illustrated in FIG. 1, the vehicle occupant protection system 500 includes a microprocessor 70, a primary processing arrangement 200, a discrete hardware safing circuit 300, a firing loop integrated circuit (FLIC) 75 and an occupant protection device 80. The occupant protection device 80 hereof represents one or more occupant protection devices of the vehicle such as an airbag, a side curtain, seatbelt pretensioners, knee bags, a steering column retractor, etc.

According to one embodiment of the present invention, the FLIC 75 deploys the occupant protection device 80 only after receiving a signal (i.e., a fire command) from the microprocessor 70 indicating the primary processing arrangement detected a crash condition. As illustrated, the discrete hardware safing circuit 300 also communicates with the microprocessor 70. A communication between the microprocessor 70 and the discrete hardware safing circuit 300 is called a Simulation Mode where the microprocessor 70 sends a request to the hardware safing circuit 300 to simulate a crash condition. According to an embodiment of the present invention and as described in greater detail below, activation of the Simulation Mode will not cause the discrete hardware safing circuit 300 to send a signal to the FLIC 75 to indicate a crash condition is present.

In the Simulation Mode, the microprocessor 70 can also send a request to the discrete hardware safing circuit 300 to check the safety/reliablity of each of the components of the discrete hardware safing circuit.

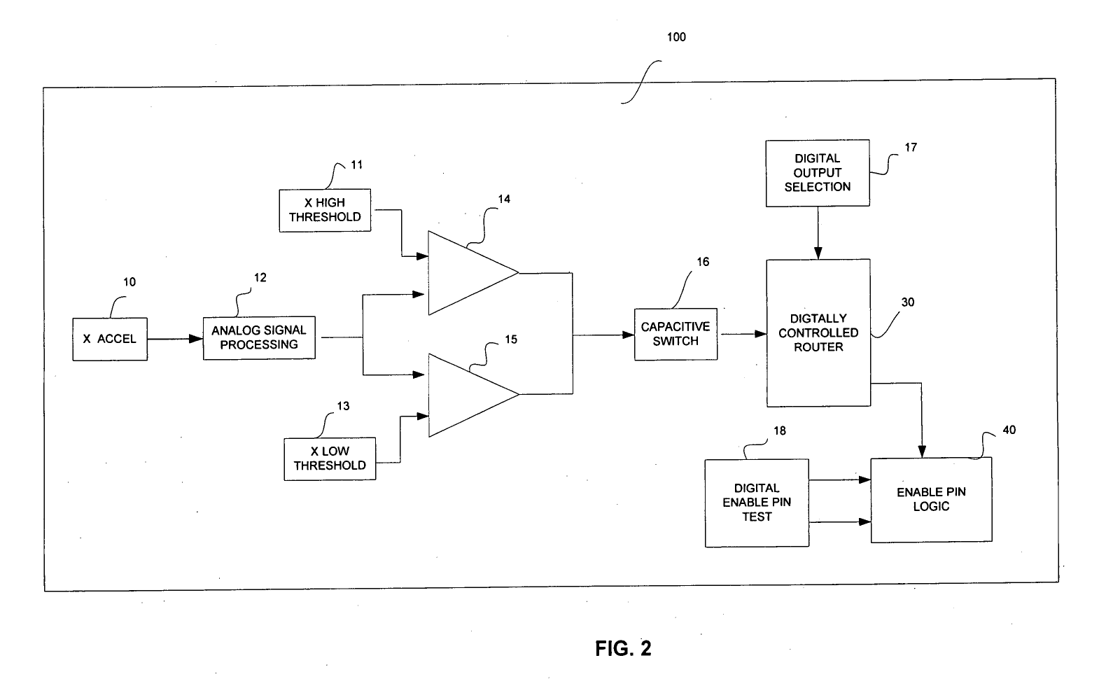

Referring now to FIG. 2, a block diagram of a one axis discrete hardware safing circuit 100 according to an embodiment of the present invention is shown. The one axis discrete hardware safing circuit 100 includes an x-accelerometer 10, an analog signal processor 12, an x-high threshold unit 11 and an x-low threshold unit 13. Comparators 14 and 15 are provided which receive the outputs from the x-high threshold unit 11 and the analog signal processor 12 and the outputs from the x-low threshold unit 13 and the analog signal processor 12, respectively. The one axis discrete hardware safing circuit 100 also includes a capacitive switch 16, a digital output selection unit 17, a digital enable pin test unit 18, a digitally controlled router 30 and an enable pin logic unit 40.

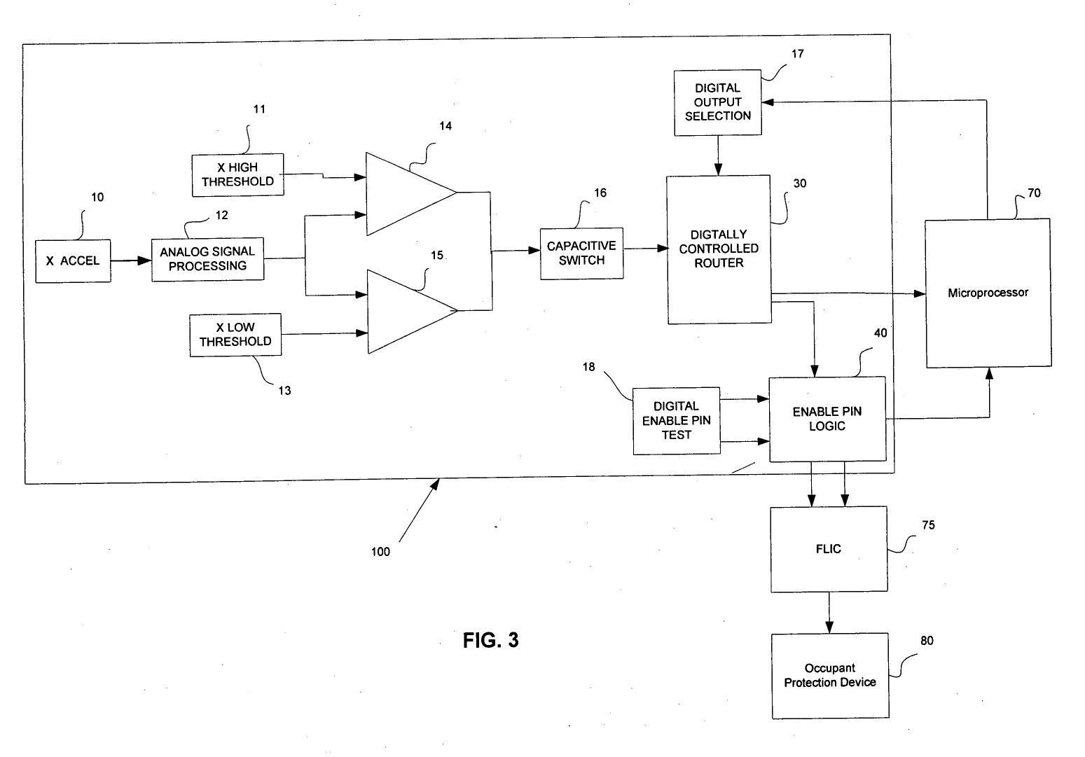

Referring briefly to FIG. 3, the one axis discrete hardware safing circuit 100 is incorporated in the vehicle occupant protection system 500 of FIG. 1. As illustrated and described in greater detail below, various components of the one axis discrete hardware safing circuit 100 communicate with the microprocessor 70. In addition, the output from the enable pin logic unit 40 is sent to the FLIC 75 which indicates a crash condition is present.

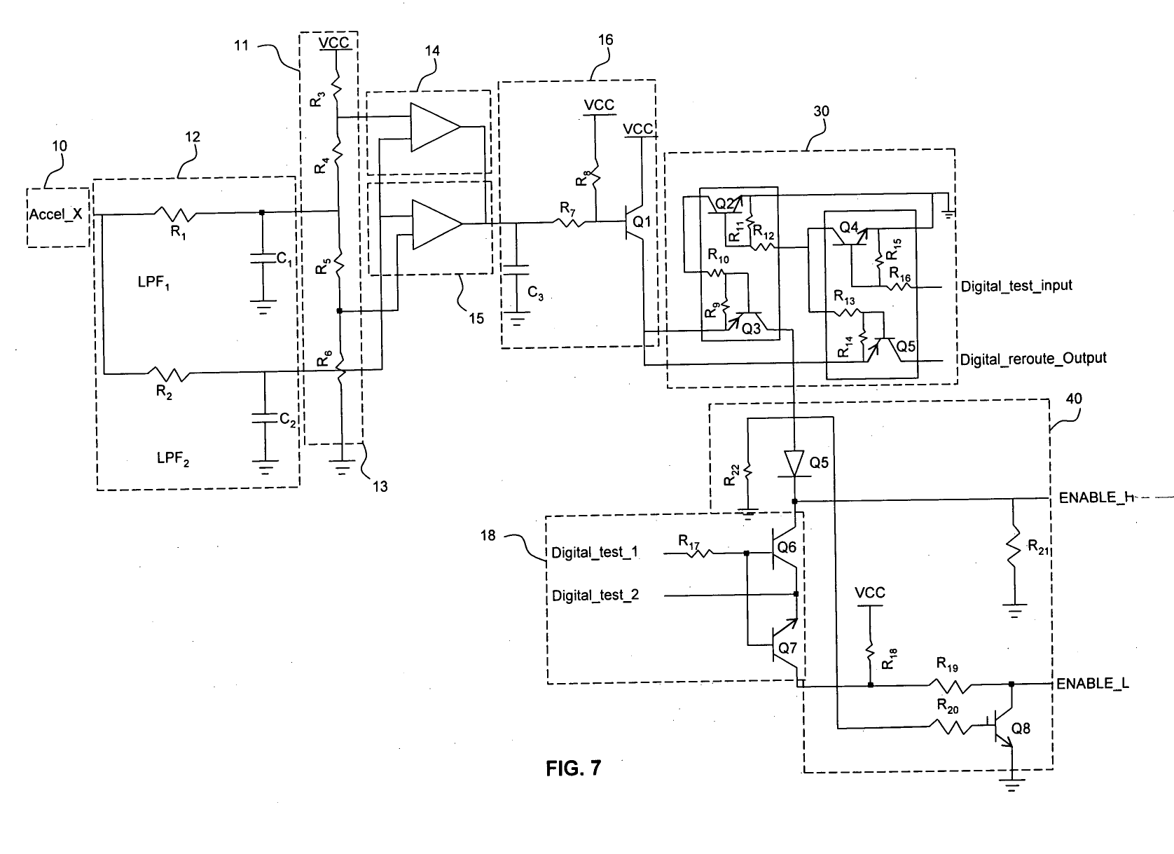

As illustrated in FIGS. 2 and 3, the x-accelerometer 10 is a sensor and outputs a signal indicative of and in proportion to the acceleration of the vehicle to the x-accelerometer which is an analog voltage signal corresponding to the acceleration of the vehicle. The analog signal processor 12 receives the analog voltage signal from the x-accelerometer 10. The analog signal processor 12 alters the signal by slowing it down and averaging it to minimize undesired noise. The analog signal processor 12 also provides assurance in the signal's magnitude. The signal from the x-accelerometer 10 is biased at 2.5 volts. Referring to FIG. 7, the analog signal processor 12 includes two low pass filters LPF1 and LPF2 which each shape the waveform of the signal. LPF1 includes resistor R1 and capacitor C1 while LPF2 includes resister R2 and capacitor C2. In addition, the cut-off frequency of LPF1 and LPF2 may, for example, be 6.8 Hz and 679 Hz, respectively.

Referring back to FIGS. 2 and 3, one input terminal of the comparator 14 receives the output signal from the analog signal processor 12 and the other input terminal receives a signal from the x-high threshold unit 11. Likewise, the comparator 15 has two input terminals wherein one input terminal receives the output from the analog signal processor 12 and the other input terminal receives a signal from the x-low threshold unit 13. The signals from the x-high threshold unit 11 and the x-low threshold unit 13 vary with the output signal from the x-accelerometer 10 through the low pass filter LPF1 of the analog signal processor 12. According to one embodiment of the present invention, the analog signal processor 12 allows the x-accelerometer 10 to offset the threshold values simultaneously to properly surround the true offset of the x-accelerometer 10. For example, if the offset of the x-accelerometer 10 is 2.45 volts instead of 2.5 volts, then both the x-high threshold unit 11 and the x-low threshold unit 13 are lowered by the low pass filter LPF1 of the analog signal processor 12 to compensate for the variation in the offset.

Likewise, the x-high and the x-low threshold units 11 and 13, respectively, are adjusted in an upward manner for an offset of the x-accelerometer 10 above 2.5 volts. For example, if the offset of the x-accelerometer 10 is 2.65 volts instead of 2.5 volts, then both the x-high threshold unit 11 and the x-low threshold unit are shifter to higher voltages by the low pass filter LPF1 of the analog signal processor 12. The ability of the x-high threshold unit 11 and the x-low threshold unit 13 as well as the LPF1 to compensated enhances the reliability of the threshold points by removing the uncertainty of a threshold's relation to the nominal offset of the x-accelerometer 10. This enhances accuracy of the trigger differential (the threshold-offset), thereby adaptively optimizing the safing solution. This discrete process removes the need of analog to digital converters typically utilized in safing solutions, and thereby removes undesirable effects associated with signal quantization. When performing operations on small signal such as ±0.15 volts, the accuracy of digitizing systems introduce sizable errors which is mitigated according to one embodiment of the present invention.

The comparator 14 compares the positive acceleration of the vehicle (i.e., the vehicle moving in a forward direction) represented by the signal from the analog signal processor 12 with a predetermined threshold stored in the x-high threshold unit 11. Likewise, the comparator 15 compares the negative acceleration of the vehicle (i.e., the vehicle moving in the backward direction) represented by the signal from the analog signal processor 12 with a predetermined threshold stored in the x-low threshold unit 13. The comparators 14 and 15 determine whether or not a signal indicating a crash condition is present depending on the output signal of the x-accelerometer 10.

Referring back to FIG. 7, the x-high threshold unit 11 and x-low threshold unit 13 include resistors R3, R4, R5 and R6 which determine an upper threshold value and a lower threshold value. As shown, the series of resistors is connected to Vcc via the high voltage end of the resistor R3 and to ground via the low voltage end of the resistor R6. In this embodiment, the x-high threshold value stored in x-high threshold unit 11 and the x-low threshold value stored in the x-low threshold unit 13 can be easily changed, for example, by changing the values of the resistors R3-R6. Thus, the discrete hardware safing circuit is easily adaptable for changes in the magnitude of the acceleration required to activate the occupant protection device 80.

As illustrated in FIGS. 2 and 3, the x-high threshold value is a signal that represents the maximum voltage established to activate the occupant protection device 80 and the x-low threshold value is a signal that is the minimum voltage established to activate the occupant protection device 80. For example, the maximum voltage could be set to any value greater than 2.5 volts (when the vehicle is going in the forward direction) and the minimum voltage value could be set to any value less than 2.5 volts (when the vehicle is going in the backward direction). However, these thresholds are nominally set at 2.7 volts and 2.3 volts, respectively.

The comparator 14 compares the output signal from the analog signal processor 12, which is a proportion of the actual voltage detected (e.g., the characteristics of the actual signal detected being changed by the low pass filter in the form of phase shifting, time delay and amplitude attenuation), with the output signal from x-high threshold unit 11. When the voltage of the output signal of the analog signal processor 12 exceeds that of the x-high threshold, the comparator 14 outputs a LOW signal. Otherwise, no signal at all is output. On the other hand, the comparator 15 compares the output signal from the analog signal processor 12 with the output signal from the x-low threshold unit 13. When the voltage of the output signal of the analog signal processor 12 falls below that of the x-low threshold, the comparator 15 also outputs a LOW signal. Otherwise, no signal at all is output.

A LOW signal from either the comparator 14 or 15 will activate the capacitive switch 16 (i.e., the capacitive switch 16 is in an ON state), whereby the output signal from capacitive switch is HIGH. Otherwise, if no signal is received from either the comparator 14 or 15, the output signal from the capacitive switch 16 remains LOW. As illustrated in FIG. 7, the capacitive switch 16 includes capacitor C3, resistors R7 and R8 and PNP transistor Q1. The charge stored in the capacitor C3 is used as a timing component. This timing component determines how long a signal is sent indicating the x-accelerometer 10 has reached a predetermined threshold as described in greater detail below. Therefore, the need for expensive components such as a microprocessor, latches resonators and software are not needed. Thereby, the overall cost of the one axis safing solution is reduced.

Once the capacitive switch 16 has been activated, a HIGH signal from the PNP transistor Q1 is sent to the digitally controlled router 30 and will continue to be sent as long as a LOW signal is received from either the comparator 14 or 15 plus for an additional amount of time. The additional amount of time varies depending largely on the value of the capacitor C3. The value of the capacitor C3 can be selected to create a delay of 300 ms according to one embodiment of the present invention.

This time delay is established to ensure sufficient arming time for the FLIC 75 to allow a proper activation of the occupant protection device 80. In other words, as the energy in the capacitor C3 is depleted and the voltage across the capacitor C3 falls, current begins to move through the PNP transistor Q1 in an attempt to recharge the capacitor C3. As the charge flows through the PNP transistor Q1's emitter-base junction, the PNP transistor Q1 enables the emitter-collector charge flow equal to beta times the charge flow through the PNP transistor Q1's emitter-base junction. The function of the capacitive switch 16 is a PNP state change predicated entirely on the charge of capacitor C3. This state change will either allow current through the PNP transistor Q1 reaching its collector, or it will inhibit current reaching its collector.

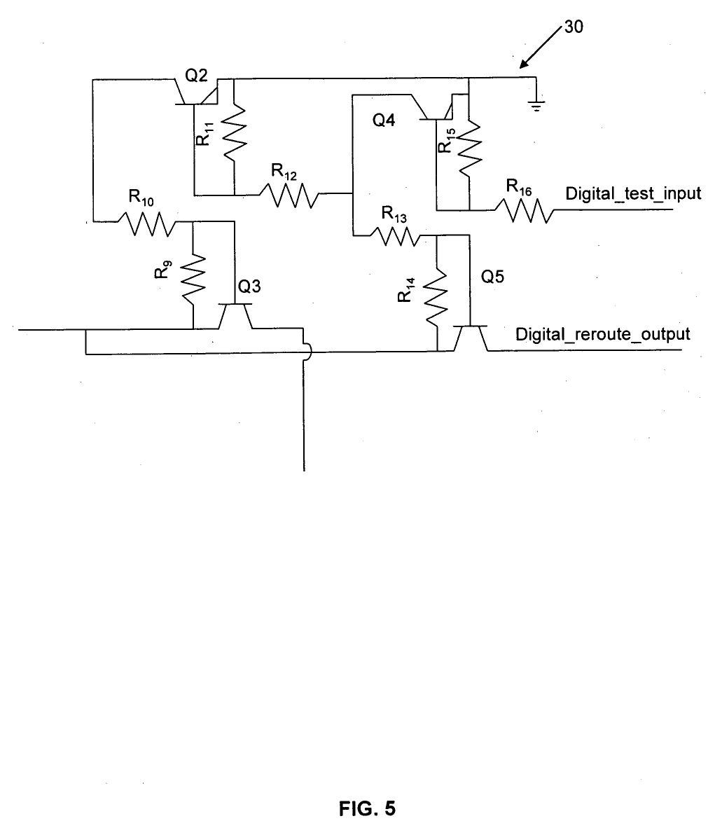

As shown in FIGS. 3, 5 and 7, when the capacitive switch 16 is in an ON-state, a HIGH signal is sent directly to the digitally controlled router 30. The digitally controlled router 30 takes the HIGH signal and directs it either to the enable pin logic unit 40 (if an actual crash condition is present) or the microprocessor 70 (in the Simulation Mode). According to one embodiment of the present invention, during the Simulation Mode, the microprocessor 70 instructs the digitally controlled router 30, via the digital output selection unit 17, to output data of a simulated crash. Software running on the microprocessor 70 can activate the x-accelerometer 10 to simulate a crash. Therefore, when the digitally controlled router 30 is provided with a HIGH signal from the digital output selection unit 17 (shown as the Digital_test_input in FIGS. 5 and 7), the output from the digitally controlled router 30 is routed to the microprocessor 70.

During the Simulation Mode a diagnostic test can be made of the following components: the x-accelerator 10, the x-high threshold unit 11, the analog signal processor 12, the comparator 14, the capacitive switch 16, the digital output selection unit 17 and the digitally controlled router 30. The x-low threshold unit 13 and the comparator 15 are not tested because the diagnostic testing of the x-accelerometer 10 only moves in the positive direction.

As illustrated in FIGS. 5 and 7, the digitally controlled router 30 includes transistor Q2, Q3, Q4, Q5 and resistors R9, R10, R11, R12, R13, R14, R15 and digital output selection unit 17 sends a signal on the Digital_test_input to the digitally controlled router 30. If the signal sent by the digital output selection unit 17 is a LOW signal, the HIGH signal received from the capacitive switch 16 is sent to the enable pin logic unit 40. If the signal sent by the digital output selection unit 17 is a HIGH signal (Simulation Mode), the HIGH signal received from the capacitive switch 16 is sent to the microprocessor 70.

As shown in greater detail in FIG. 5, for transistor Q3 or transistor Q5 to be active, there must be a signal from capacitive switch 16. If and only if there is a signal from the capacitive switch 16 then Digial_test_input matters at all. If there is a HIGH signal from the capacitive switch 16 then Digital_test_input can be used to select which direction the signal will go, either to enable pin logic 40 or the microprocessor 70. The transistor Q4 is controlled by the Digital_test_input and the transistor Q2 is controlled by the transistor Q4 and the capacitive switch 16. Therefore, in order for the transistor Q2 to be turned ON, the transistor Q4 has to be turned OFF and there must be a HIGH signal from the capacitive switch 16. Thus, if Digital_test_input is HIGH and transistor Q1 is HIGH, then transistor Q4 and transistor Q5 are ON and transistor Q2 and Q3 are OFF. If Digital_test_input is LOW and transistor Q1 is HIGH, then transistor Q4 and transistor Q5 are OFF and transistor Q2 and transistor Q3 are ON. If transistor Q1 is OFF, then there is no output from the digitally controlled router 30.

Referring back to FIGS. 2 and 3, the enable pin logic unit 40 receives inputs from the digitally controlled router 30 and the digital enable pin test unit 18. According to one embodiment of the present invention, the enable pin logic unit 40 has two main functions. The first function of the enable pin logic unit 40 is to enter and exit the FLIC 75 test conditions safely. As discussed in greater detail below, the enable pin logic unit 40 includes two enable pins. One enable pin controls the high side drivers of the FLIC 75 and the other enable pin controls the low side drivers of the FLIC 75.

If only one of the high side drivers or the low side drivers are activated, the FLIC 75 can perform diagnostic tests without a potential for accidentally deploying the occupant protection device 80. If both the high side drivers and the low side drivers are activated, then the occupant protection device 80 can be deployed. If both the high side drivers and the low side drivers are not activated then neither the occupant protection device 80 can be deployed nor can the diagnostic tests be performed. Some diagnostic tests require the high side drivers to be activated while some diagnostic tests require the low side driver to be activated. Only one diagnostic test requires both the high side drivers and the low side drivers to be activated for a short period of time and that diagnostic test is performed shortly after the engine is switched on.

The second function of the enable pin logic unit 40 is to enable the FLIC 75 in the case of a safing event (i.e., a crash condition is present). When the discrete hardware safing circuit 100 activates both the enable pins (i.e., Enable_H is HIGH and Enable_L is LOW) then the FLIC 75 knows that a safing event has occurred. If a safing event occurs without a fire-command from the microprocessor 70, the FLIC 75 will not fire to activate the occupant protection device 80. Likewise, if the microprocessor 70 sends a fire-command to the FLIC 75 and the discrete hardware safing circuit 100 does not have both enable pins activated, then the FLIC 75 will not fire to activate the occupant protection device 80. Therefore, only if the discrete hardware safing circuit 100 has both enable pins activated and the microprocessor 70 sends a fire command, will the occupant protection device 80 be activated.

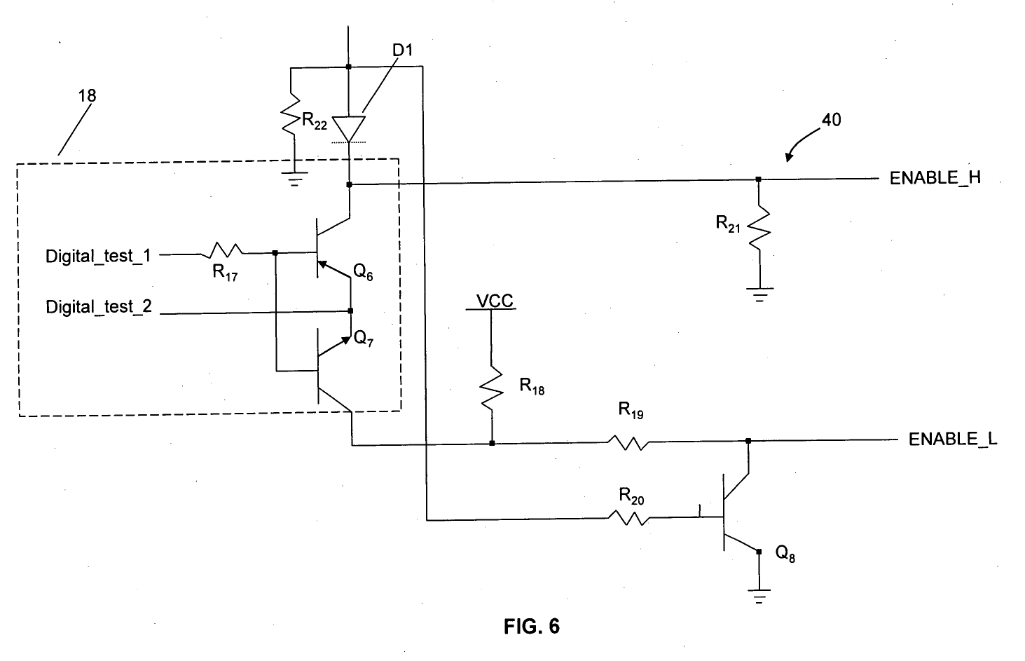

As illustrated in FIG. 6, the enable pin logic unit 40 receives input signals from the digital enable pin test unit 18 and the digitally controlled router 30. The input signals from the digital enable pin test unit 18 include a Digital_test_1 signal and a Digital_test_2 signal. The input signal from the digitally controlled router 30 is either a HIGH signal or a LOW signal. A HIGH signal from the digitally controlled router 30 indicates that a safing event has taken place and the digital output selection unit 17 sent a LOW signal to the digitally controlled router 30 indicating the Simulation Mode is not set. A LOW signal from the digitally controlled router 30 indicates a safing event has not been demonstrated.

As shown in FIG. 6, the enable pin logic unit 40 includes circuitry to activate the Enable_H pin and the Enable_L pin. The Enable_H pin controls the high side drivers within the FLIC 75 and the Enable_L pin controls the low side drivers within the FLIC 75. These enable pins are of opposite polarity. For an occupant protection device 80 to be deployed, both enable pins must be activated. To activate the Enable_H pin, a HIGH signal must be received (i.e., provided with a digital high 5V signal). To activate the Enable_L pin, a LOW signal must be received (i.e., provided with a digital low 0V signal). Both of these enable pins are activated if a HIGH signal is received from the comparator switch 16 through the digitally controlled router 30.

The enable pin logic unit 40 includes a diode D1, resistors R18, R19, R20, R21 and R22 and NPN transistor Q8 and a voltage source Vcc. The output from the digitally controlled router 30 is sent to the diode D1. Also shown in FIG. 6 is a circuit diagram for the digital enable pin test unit 18. The digital enable pin test unit 18 includes a resistor R17 and a PNP transistor Q6 and an NPN transistor Q7. Table 1 below includes the various input conditions for the digital enable pin test unit 18 as well as the outputs for the Enable_H and Enable_L pins and the status of the FLIC's readiness to fire.

TABLE 1

| Condition | Digital_Test_1 | Digital_Test_2 | From DCR | Enable_H | Enable_L | Status |
|---|---|---|---|---|---|---|
| I | HIGH | HIGH | LOW | LOW | HIGH | NO |
| II | HIGH | LOW | LOW | LOW | LOW | NO |
| III | LOW | HIGH | LOW | HIGH | HIGH | NO |
| IV | LOW | LOW | LOW | LOW | HIGH | NO |
| V | HIGH | HIGH | HIGH | HIGH | LOW | YES |
| VI | HIGH | LOW | HIGH | HIGH | LOW | YES |
| VII | LOW | HIGH | HIGH | HIGH | LOW | YES |
| VIII | LOW | LOW | HIGH | HIGH | LOW | YES |

Referring back to FIG. 6, at condition I from Table 1, a LOW signal from the digitally controlled router 30 indicates a safing event has not taken place. This LOW signal is sent to the diode D1 and also the NPN transistor Q8. The LOW signal from the digitally controlled router 30 keeps the NPN transistor Q8 turned OFF and the diode D1 LOW. With the diode D1 LOW, the Enable_H pin is LOW or not activated. The Digital_test_1 and the Digital_test_2 work together in order to turn ON either transistor Q6 or Q7. In other words, there must be a state differential between Digital_test_1 and Digital_test_2 to enable either transistor Q6 or Q7. Therefore, at condition I, since Digital_test_1 and Digital_test_2 are HIGH, there is no state change so transistors Q6 and Q7 are both OFF. With all of the transistors being OFF, Enable_L remains HIGH or not activated because of the voltage source Vcc. The occupant protection device is not armed since no safing event has taken place. This is true for the next three conditions.

At condition II, the LOW signal from the digitally controlled router 30 keeps the NPN transistor Q8 turned OFF. Also, the LOW signal to diode D1 keeps the diode LOW and thus, the Enable_H pin is LOW or not activated. A HIGH signal on Digital_test_1 and a LOW signal on Digital_test_2 keeps PNP transistor Q6 OFF and turns NPN transistor Q7 ON. With NPN transistor Q7 being ON, Enable_L line is pulled LOW and Enable_L pin is activated.

At condition III, the LOW signal from the digitally controlled router 30 keeps the NPN transistor Q8 turned OFF. Also, the LOW signal to diode D1 keeps the diode LOW. A LOW signal on Digital_test_1 and a HIGH signal on Digital_test_2 turns PNP transistor Q6 ON and turns NPN transistor Q7 OFF. With PNP transistor Q6 being ON current flow through the transistors making Enable_H HIGH or activated. With NPN transistor Q7 being OFF, the voltage source Vcc keeps Enable_L HIGH and thus not activated.

At condition IV, the LOW signal from the digitally controlled router 30 keeps the NPN transistor Q8 turned OFF. Also, the LOW signal to diode D1 keeps the diode LOW and thus, the Enable_H pin is LOW or not activated. A LOW signal on Digital_test_1 and a LOW signal on Digital_test_2 keeps both transistors Q6 and Q7 OFF. Thus, with the NPN transistor Q7 being OFF, the voltage source Vcc keeps Enable_L HIGH and thus not activated.

At condition V, a HIGH signal from the digitally controlled router 30 indicates that a safing event has taken place. The HIGH signal keeps the NPN transistor Q8 tuned ON. Also, the HIGH signal to diode D1 keeps the diode HIGH and thus, the Enable_H pin is always HIGH or activated. A HIGH signal on Digital_test_1 and a High signal on Digital_test_2 keeps transistors Q6 and Q7 OFF. With transistor Q8 always being ON, the Enable_L line is pulled LOW and the Enable_L pin is activated. Thus, Enable_L is always LOW or activated. The occupant protection device is armed since a safing event has taken place. Whether transistors Q6 or Q7 are ON or OFF have no affect on the circuit because a safing event has taken place which overrides the enable pin test logic. This is further illustrated in the conditions below.

At condition VI, the HIGH signal from the digitally controlled router 30 keeps the NPN transistor Q8 tuned ON, pulling the Enable_L line LOW and activating the Enable_L pin. Also, the HIGH signal to diode D1 keeps the diode HIGH and thus, the Enable_H pin is HIGH or activated. A HIGH signal on Digital_test_1 and a LOW signal on Digital_test_2 keeps the PNP transistor Q6 OFF and turns the NPN transistor Q7 ON. This does not change the state of the enable pins.

At condition VII, the HIGH signal from the digitally controlled router 30 keeps the NPN transistor Q8 tuned ON, pulling the Enable_L line LOW and activating the Enable_L pin. Also, the HIGH signal to diode D1 keeps the diode HIGH and thus, the Enable_H pin is HIGH or activated. A LOW signal on Digital_test_1 and a HIGH signal on Digital_test_2 turns the PNP transistor Q6 ON and turns the NPN transistor Q7 OFF. This does not change the state of the enable pins.

At condition VIII, the HIGH signal from the digitally controlled router 30 keeps the NPN transistor Q8 tuned ON, pulling the Enable_L line LOW and activating the Enable_L pin. Also, the HIGH signal to diode D1 keeps the diode HIGH and thus, the Enable_H pin is HIGH or activated. A LOW signal on Digital_test_1 and a LOW signal on Digital_test_2 keeps both transistors Q6 and Q7 turned OFF.

In summary, in order to utilize the diagnostics of the enable pin logic, it is necessary to enable only one enable pin at a time. If both Digital_test_1 and Digital_test_2 have the same voltage (i.e., both are HIGH or both are LOW), then both the Enable_H and Enable_L will remain inactive. However, if Digital_test_2 is HIGH and Digital_test_1 is LOW, the Enable_H will be active and the Enable_L will be inactive. Likewise, if Digital_test 2 is LOW and Digital_test 1 is HIGH, then Enable_L will be active while Enable_H is inactive.

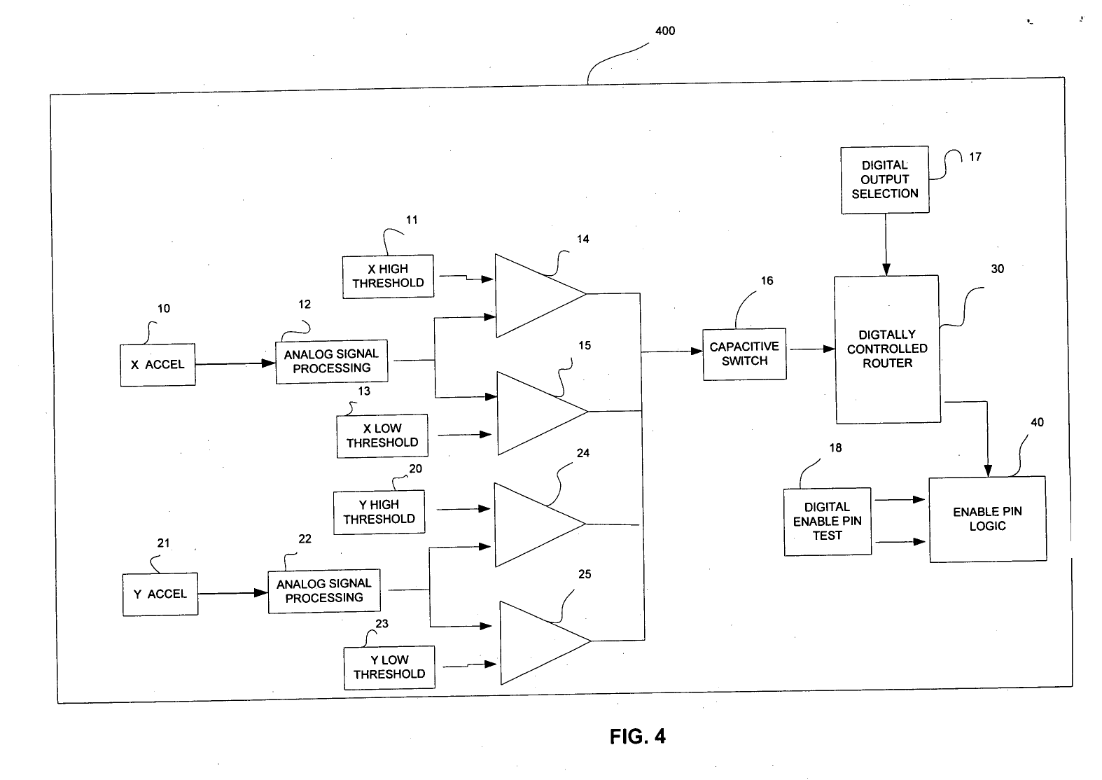

Referring now to FIG. 4, a second embodiment of the present invention is illustrated. FIG. 4 illustrates a two axis discrete hardware safing circuit 400 for activating an occupant protection device 80. As illustrated, the two axis discrete hardware safing circuit 400 includes the same components shown in FIG. 2 with the addition of a y-accelerometer 21, a y-high threshold unit 20, a y-low threshold unit 23, a second analog signal processor 22, and two additional comparators 24 and 25. The two axis discrete hardware safing circuit 400 operates essentially in the same manner as the one axis discrete hardware safing circuit 100 but with the inclusion of detecting positive and negative acceleration on the y-axis.

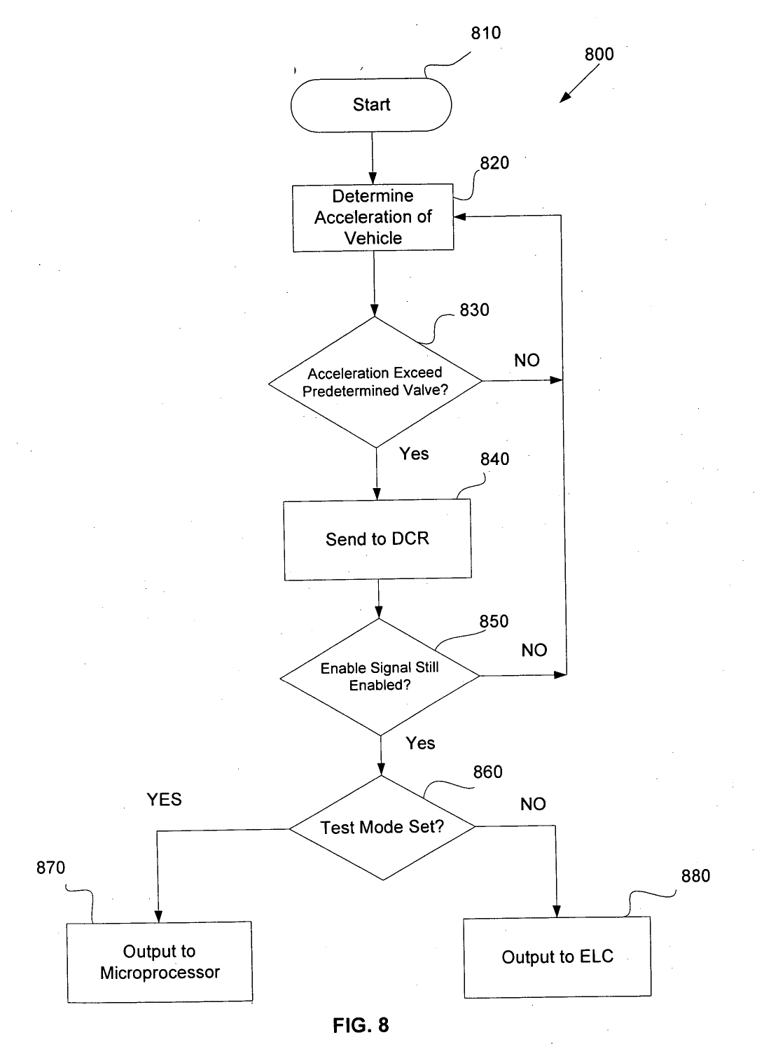

An example of a process 800 that embodies the present invention is shown in FIG. 8. A process 800 is initiated at step 810. At step 820 the acceleration of a vehicle is determined. At step 830, it is determined whether the acceleration of the vehicle exceeds a predetermined threshold value (e.g., the threshold value could be the x-high threshold value or the x-low threshold value or both values as illustrated in FIG. 2). If the determination is YES, the process 800 proceeds from step 830 to step 840. If the determination of step 830 is NO, the process 800 returns to step 820.

At step 840, a enable signal indicating that the predetermined threshold was exceeded is sent to a router. At step 850, it is determined whether the enable signal is still enabled using a capacitive switch. If the determination is YES, the process 800 proceeds from step 850 to step 860. If the determination of step 850 is NO, the process 800 returns to step 820. At step 860, it is determined whether a test mode has been set. If the determination is YES, the process 800 proceeds from step 860 to step 870. If the determination is NO, the process 800 proceed from step 860 to step 880. At step 870 a microprocessor receives the enable signal indicating the predetermined threshold was exceeded for test purposes. At step 880 the enable signal is used for determining whether an occupant protection device should be deployed.

The embodiments disclosed herein are to be considered in all respects as illustrative, and not restrictive of the invention. The present invention is in no way limited to the embodiments described above. Various modifications and changes may be made to the embodiments without departing from the spirit and scope of the invention. The scope of the invention is indicated by the attached claims, rather than the embodiments. Various modifications and changes that come within the meaning and range of equivalency of the claims are intended to be within the scope of the invention.

What is claimed:

1. A discrete hardware safing circuit, comprising:
a sensor that provides a signal indicating a vehicle acceleration in a direction;
at least one comparator that determines if the vehicle acceleration exceeds a predetermined threshold;
a capacitive switch activated based on a determination from the at least one comparator that the predetermined threshold was exceeded and remaining activated as long as the predetermined threshold is exceeded and for an additional time period; and
a router that routes an enable signal based on the activation of the capacitive switch.

2. The discrete hardware safing circuit according to claim 1, wherein the threshold can be dynamically adjusted.

3. The discrete hardware safing circuit according to claim 1, wherein the vehicle acceleration is in the x direction.

4. The discrete hardware safing circuit according to claim 1, wherein the enable signal is provided to a microprocessor.

5. The discrete hardware safing circuit according to claim 1, wherein the enable signal is provided to a pin logic circuit.

6. The discrete hardware safing circuit according to claim 4, wherein the enable signal is used for a diagnostic test.

7. The discrete hardware safing circuit according to claim 4, wherein the enable signal is used for a simulation test.

8. The discrete hardware safing circuit according to claim 5, wherein the enable signal is used to activate an occupant protection device.

9. A vehicle occupant protection system, comprising:
a sensor that provides a signal indicating a vehicle acceleration in a direction;
at least one comparator that determines if the vehicle acceleration exceeds a predetermined threshold;
a capacitive switch activated based on a determination from the at least one comparator that the predetermined threshold was exceeded and remaining activated as long as the predetermined threshold is exceeded and for an additional time period;
a router that routes an enable signal based on the activation of the capacitive switch to an enable logic circuit for pin activation
a processor providing a vehicle crash condition signal;
a deployment device that deploys an occupant protection device based on the vehicle crash condition signal and the pin activation.

10. The vehicle occupant protection system according to claim 9, wherein, the threshold can be dynamically adjusted

11. The vehicle occupant protection system according to claim 9, wherein, the vehicle acceleration is in the x direction.

12. The vehicle occupant protection system according to claim 9, wherein the enable signal is provided to a microprocessor.

13. The vehicle occupant protection system according to claim 12, wherein the enable signal is used for a diagnostic test.

14. The vehicle occupant protection system according to claim 12, wherein the enable signal is used for a simulation test.

15. A method for operating a discrete hardware safing circuit, comprising:
providing a signal indicating a vehicle acceleration in a direction;
determining if the vehicle acceleration exceeds a predetermined threshold;
activating a capacitive switch based on a determination that the predetermined threshold was exceeded and keeping the capacitive switch activated as long as the predetermined threshold is exceeded and for an additional time period; and
routing an enable signal based on the activation of the capacitive switch.

16. The method for operating a discrete hardware safing circuit according to claim 15, further comprising dynamically adjusting the threshold.

17. The method for operating a discrete hardware safing circuit according to claim 15, further comprising providing the vehicle acceleration in the x direction.

18. The method for operating a discrete hardware safing circuit according to claim 15, further comprising providing the enable signal to a microprocessor.

19. The method for operating a discrete hardware safing circuit according to claim 15, further comprising providing the enable signal to a pin logic circuit.

20. The method for operating a discrete hardware safing circuit according to claim 18, further comprising using the enable signal for a diagnostic test.
